(19) United States
(12) Patent Application Publication
(10) Pub. No.: US 2008/0001316 A1
(43) Pub. Date: Jan. 3, 2008

(54) Apparatus and Method for Producing Embossed Film

(76) Inventors: Sanjog Shyam Jain, Pune (IN); Narasimha Acharya, Bangalore (IN); Shailendra Pramod Joshi, Maharashtra (IN); Ashwit Dias, Goa (IN); Nitin Vaish, Evansville, IN (US)

Correspondence Address: CANTOR COLBURN, LLP, 55 GRIFFIN ROAD SOUTH, BLOOMFIELD, CT, 06002, US

(21) Appl. No.: 11/427,563

(22) Filed: Jun. 29, 2006

(51) Int. Cl. B29D 11/00

(52) U.S. Cl. 264/1.1; 425/363

(57) ABSTRACT

Disclosed herein are embossing lines and methods for their use. In one embodiment an embossing line comprises: an embossing belt disposed about a heating roll and a chill roll, a joining roll disposed between the heating roll and the chill roll, and a pre-embossing heater disposed between the joining roll and the heating roll such that the substrate film can be heated by the pre-embossing heater prior to the embossing belt contacting the heating roll. In another embodiment, a film making process is disclosed.

### BACKGROUND

Disclosed herein are optical films, and, in particular, a method and apparatus for producing an embossed film.

Optical films can be manufactured with specialized optical properties that can direct, diffuse, and polarize light. Such films are desirable in applications, such as backlight displays (e.g., flat screen monitors), televisions (e.g., plasma and LCD), personal electronics (e.g., PDA's, personal entertainment systems, and cellular phones), illuminated signs, and in many other applications. Optical films can comprise prismatic surface features that are disposed on a surface of the film which are capable of directing light along a viewing axis (i.e., an axis normal (perpendicular to the display). This capability enhances the perceived display brightness while allowing the device on which it is employed to operate at a reduced power consumption level.

Optical films can be formed by many methods, such as an embossing process. During the embossing process, a film is heated to a temperature above its glass transition temperature and forced against a pattern (e.g., embossing belt, embossing drum), which comprises features that are a negative image of the features desired. As the heated film is forced against the pattern, the film flows into the surface features. The film is then cooled below its glass transition temperature and stripped from the pattern.

The replication fidelity of the resulting surface features is central to the quality of the finished product. To achieve a desirable level of replication, the embossing apparatus is generally operated at low throughput speeds to allow ample time for the film to assume the shape of surface features on the pattern. As a result, there is a continued need for innovations in embossing apparatus technology that can provide increased production rates while maintaining high replication fidelity.

### SUMMARY OF THE INVENTION

Disclosed herein are embossing lines that are capable of producing embossing films. Also disclosed are methods for their use.

In one embodiment an embossing line is disclosed. The embossing line comprises: an embossing belt disposed about a heating roll and a chill roll, a joining roll disposed between the heating roll and the chill roll such that the joining roll can dispose a substrate film on the embossing belt prior to the embossing belt contacting the heating roll, and a pre-embossing heater disposed between the joining roll and the heating roll such that the substrate film can be heated by the pre-embossing heater prior to the embossing belt contacting the heating roll.

In another embodiment, an embossing line comprises: an extruder capable of extruding a polymer melt onto a nip section between an embossing drum and a compression drum to form an embossed film, and a cooling apparatus capable of cooling the embossed film. The cooling apparatus comprises a cooling jet and a vacuum conduit.

In one embodiment, a film making process comprises: disposing a substrate film and a support film on an embossing belt to form a supported film, heating the supported film to form a heated supported film, introducing the heated supported film into a first nip section, and forming an embossed film. The embossed film comprises surface features.

In another embodiment, a film making process comprises: extruding a polymer melt onto a nip section formed by an embossing drum and a compression drum, forming an embossed film, blowing a cooling media at a surface of the embossed film, removing heat energy from the embossed film with the cooling media to form a warmed media, and applying a vacuum to at least a portion of the warned media. The embossed film comprises surface features.

The above described and other features are exemplified by the following figures and detailed description.

### BRIEF DESCRIPTION OF THE DRAWINGS

Refer now to the figures, which are meant to be exemplary and not limiting, and wherein like elements are numbered alike.

FIG. 1 is a side view of an exemplary embossing line.

FIG. 2 is a side view of an exemplary extrusion embossing process.

FIG. 3 is a cross-sectional front view of an exemplary cooling apparatus.

FIG. 4 is an exemplary graph illustrating embossing depth plotted with respect to time.

FIG. 5 is an exemplary graph illustrating the heat transfer effects of the redesigned cooling apparatus.

FIG. 6 is an exemplary graph illustrating embossing replication plotted with respect to time.

### DETAILED DESCRIPTION OF THE INVENTION

A deficiency remains in the art of embossing polymer films with regard to methods for increasing process line-speeds while maintaining replication fidelity. Although not limited by theory, it has been theorized by the applicants that a potential cause of inferior replication fidelity at higher line speeds is due to the rate at which a polymer film can absorb and dissipate heat. To be more specific, as line-speed increases, the amount of time that an embossing apparatus (e.g., embossing belt, or embossing drum) is in contact with a polymer film decreases. Respectively, the amount of time the embossing apparatus has to transfer heat to the polymer film (e.g., substrate film), and the amount of time the polymer film has to absorb heat from the embossing apparatus, is decreased. The lower the temperature of the film is during embossing, the higher will be elastic strain energy recovery will be on the removal of the embossing pressure. As a result, the polymer will exhibit an elastic response. If the embossed film exhibits an elastic response, the surface of the film will not retain the shape of the features on the embossing apparatus after the embossed film is removed therefrom. This results in poor replication fidelity of the surface features.

Replication fidelity can be measured by comparing the height of the surface features formed on an embossed film 32 to the depth of the surface features disposed on the embossing apparatus (e.g., embossing belt 16 or embossing drum 68). For example, if an embossing belt comprising surface features having a depth of about 1.0 mm (39.4 mil) is employed to manufacture an embossed film 32, and the embossed film 32 exhibits surface features that are about 0.95 mm (37.4 mil) in height, the embossed film exhibits about 95% replication. If an embossed film 32 exhibits a replication percentage that is equal to or greater than about 80%, the film is considered to be acceptable; however, embossed films that exhibit a replication percentage that is equal to or greater than about 85%, or even more specifically, equal to or greater than about 90%, are more desired.

To improve replication fidelity, a process has been developed wherein a substrate film is disposed on the embossing belt and preheated prior to being embossed. By supporting the film on the embossing belt, the substrate film can absorb additional heat energy prior to being embossed, which reduces and/or eliminates the elastic response of the substrate film at higher production rates. The preheating process can also comprise disposing a support film onto the substrate film, which can support the substrate film as it is heated. As will be disclosed, the substrate film, embossing belt, and support film, can be individually and/or collectively heated prior to being disposed in contact with one another, and/or heated after they are joined, prior to embossing. The embossing belt also ensures that the heated film is gripped properly on to the belt, thereby ensuring less thinning of the embossing film. The main objective of backing film is to have a smooth surface on other side of embossed film and to inhibit sticking to the rubber/pressure rolls.

In addition to preheating the substrate film prior to embossing, the process herein can employ a cooling apparatus that is capable of actively cooling the polymer film after the embossing process, which can also affect line speeds. To be more specific, a cooling apparatus incorporating cooling jets and vacuum conduits can efficiently remove heat from the embossed film and/or embossing apparatus.

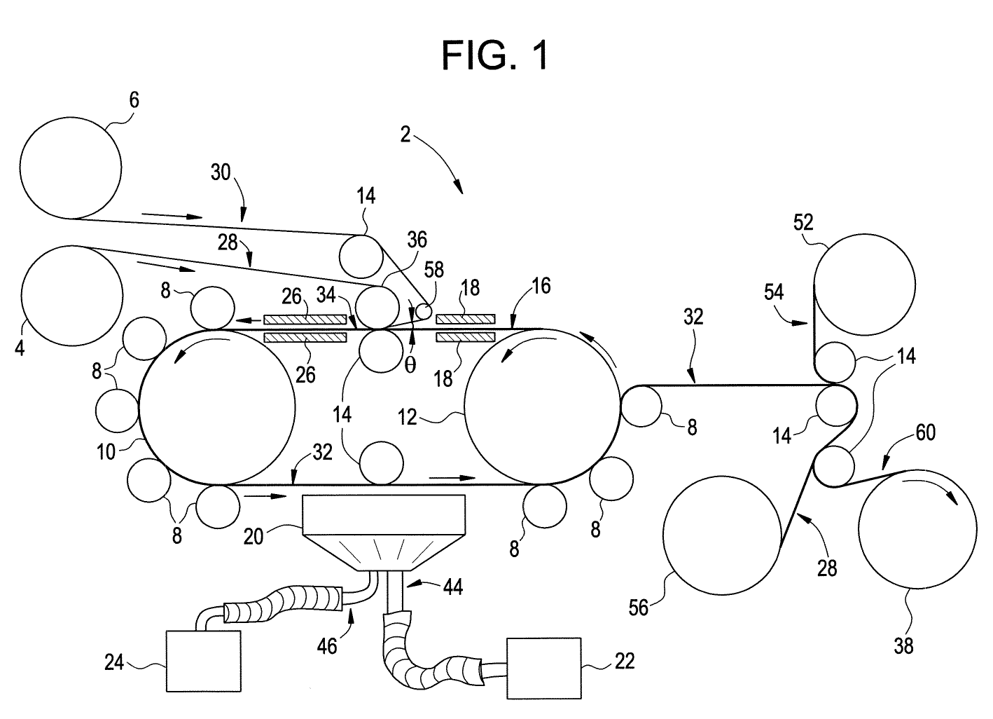

Referring now to FIG. 1, a side view of an exemplary embossing line, generally designated 2, is illustrated. In the illustration, an embossing belt 16 travels about a heating roll 10 and a chill roll 12 as shown by the directional arrows. The embossing belt 16 is supported between the heating roll 10 and the chill roll 12 by two support rolls 14. As the embossing belt 16 advances away from the chill roll 12 in the direction shown, it can be heated by a belt heater 18 and/or a pre-embossing heater 26 prior to contacting the heating roll 10. The pre-heater 26 can also be used to just heat the film 30, particularly on the side in physical contact with the belt 16.

A substrate film roll 6 supplies a substrate film 30 to the embossing line 2. The substrate film 30 is routed via a support roll 14 to an idler roll 58, which then routes the substrate film 30 to a joining roll 36. The idler roll 58 can increase (or maximize) the angle between substrate film and support film prior to joining between the nip formed by rolls 36 and 14. This inhibits air from getting trapped between the film. A support film 28 is also supplied to the hot embossing line 2 via a support film roll 4. The support film 28 is routed from the support roll 4 to the joining roll 36. At the joining roll 36, the support film 28 and the substrate film 30 are joined together, forming a supported film 34, which is disposed on the preheated embossing belt 16. Upon contact with the preheated embossing belt 16, the embossing belt 16 can heat the supported film 34. Thereafter, the supported film 34 can be further heated by a pre-embossing heater 26 as the supported film 34 and the embossing belt 16 advances towards a compression roll 8 (as illustrated by the direction arrows). The compression roll(s) 8 and the heated roll 10 form a “nip”, or “nip section”, that is capable of compressing the supported film 34 and the embossing belt 16 therebetween. When the supported film 34 and embossing belt 16 enter the nip section, the supported film 34 is compressed against the embossing belt 16, forcing the substrate film 30 to be embossed with the surface features that are disposed on the embossing belt 16 (not shown).

A plurality of compression rolls 8 can be disposed in an annular array about the heated roll 10 to further compress, and/or maintain pressure on, the supported film 34. This array of compression rolls 8 can be employed so that the substrate film 30 is held in contact with the embossing belt 16 for a longer period of time. This prolonged contact allows the substrate film 30 additional time to assume the form of the surface features on the embossing belt 16 and thereby encourages replication fidelity. When the substrate film 30 exits the last nip section, an embossed film 32 has been formed.

The embossed film 32 then travels with the embossing belt 16 under a cooling apparatus 20 that is capable of removing heat from the embossed film 32. The cooling apparatus 20 can be disposed between the heating roll 10 and the chill roll 12, however can also be disposed in any position that it can be effective at removing heat from the embossed film 32. The cooling apparatus 20 is connected in operable communication with an air source 22 and a vacuum source 24.

The embossed film 32 then travels on the embossing belt 16 under a series of compression rolls 8 disposed in an annular array about the chill roll 12, wherein additional heat is removed from the embossed film 32. Thereafter, the embossed film 32 is stripped from the embossing belt 16 and joined with a masking film 54 that is fed to the embossing line 2 by a masking film roll 52. Thereafter, the support film 28 is removed and the masked embossed film 60 travels along support rolls 14 and is spooled on a take-up roll 38.

The support film is stripped from embossed film 32, before or after masking is applied, and is wound on take-up roll 56. This support film can be further re-used based on process and product requirements.

The embossing line 2 illustrated in FIG. 1 is capable of achieving increased line speeds, while maintaining acceptable replication fidelity, because the embossing line 2 can heat the support film 28 before it is embossed to a higher temperature than that which can be achieved by alternative embossing processes. By achieving a higher support film 28 temperature before it is embossed, the film's elastic response is reduced and/or eliminated at higher rates of production, wherein the overall time the substrate film 30 is in contact with the nip sections is reduced. The embossing line 2 can achieve these higher support film 28 temperatures by employing a joining roll 36 and a pre-embossing heater 26. To be more specific, the joining roll 36 disposes the substrate film 30 on the embossing belt 16 before it is heated by the pre-embossing heater 26 and enters the first nip section. As a result, the embossing belt 16 and support film 28 support the substrate film 30 as it is heated and thereby reduce the likelihood of the substrate film 30 stretching and/or deforming as it is heated.

The idler roll 58 (which defines the angle between the substrate film 30 and the joining roll 36) is disposed such that the substrate film 30 can be supplied to the joining roll 36 at an acute angle θ. To be more specific, the acute angle θ can comprises an angle that is greater than or equal to about 15°, or more specifically greater than or equal to about 30°, or even more specifically, greater than or equal to 45°. By employing the idler roll 58 and supplying the support film 28 to the joining roll 36 at an acute angle θ, the air trapped between the substrate film 30 and the embossing belt 16 is decreased.

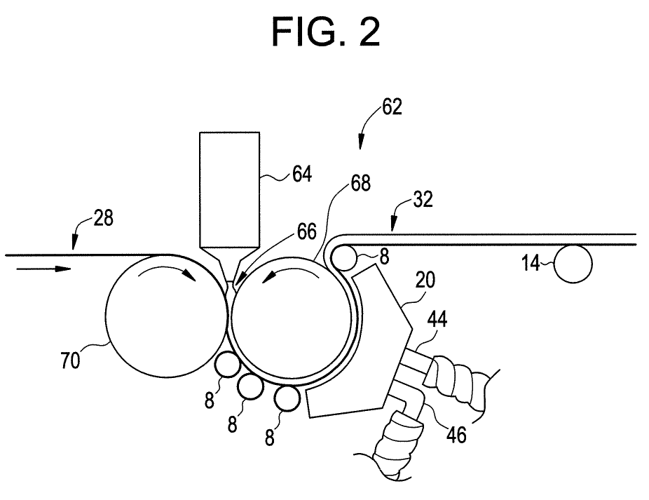

Referring now to FIG. 2, a side view of an exemplary extrusion embossing process, generally designated 62, is shown. In the illustration, an extruder 64 provides a polymer melt 66 that is disposed between a support film 28 and an embossing drum 68, wherein the support film 28 is supported by a compression drum 70. The extrudate is then compressed between the compression drum 70 and the embossing drum 68, which can be referred to as a “nip” or “nip section”. When the polymer melt 66 is compressed against the embossing drum 68 at the nip, the polymer melt 66 flows into the surface features (not shown) disposed on the surface of the embossing drum 68. Thereafter, a plurality of compression rolls 8 disposed in an annular array about the embossing drum 68 further compress and/or maintain pressure on the polymer melt 66 against the embossing drum 68, which encourages replication fidelity and forms an embossed film 32. The embossing drum 68 can be temperature controlled, such as to cool the polymer melt 66 upon contact, utilizing cooling methods such as flowing a cooled fluid media through internal channels within the drum. The embossed film 32 can also travel under a cooling apparatus 20, which is capable of removing heat from the embossed film 32. Once cooled, the embossed film 32 is stripped from the embossing drum 68.

The embossing line 2 and extrusion embossing process 62 described herein can be capable of producing an embossed film 32 at a rate greater than or equal to about 10 feet per minute, ft/min (3.05 meters per minute, M/min). However, a rate greater than or equal to about 20 ft/min (6.10 M/min), or even greater than or equal to about 30 ft/min (9.15 M/min), is possible. These rates are possible in the present process while maintaining a replication percentage of greater than or equal to about 90%.

The support film 28 functions to support the substrate film 30 as it is preheated. In addition, the support film 28 can protect the surface finish of the substrate film 30 during the embossing process and prevent the substrate film 30 from adhering to the compression rolls 8. Polymeric materials can be employed for the support film 28 (e.g., homopolymers, copolymers, polymer blends, and polymer reaction products), however it is desirable that the support film 28 comprise a higher glass transition temperature (Tg) (or, in the case of a semi-crystalline polymer, higher melting temperature (Tm)) than the substrate film 30 to minimize deformation of the supported film 34 as it is preheated, and to prevent the support film from sticking to the polymer being embossed. To ensure integrity of the film stack, the substrate film 30 should not be heated above its Tg prior to joining it with the support film 28 (The Tg/Tm of the support film is one of the factors which governs the maximum temperature at which the embossing can take place.) One such polymer that has exhibited success in this application is polyethylene terephthalate (e.g., Mylar, manufactured by E. I. du Pont de Nemours and Company, Wilmington, Del.). Polyethylene terephthalate can support the substrate film 30 during the preheating process and does not adhere to many substrate film 30 materials, which allows the support film 28 to be easily removed therefrom. The support film 28 can comprise a thickness of greater than or equal to about 50 micrometers (μm)), or, more specifically, about 50 μm to about 500 μm.

Substrate film 30 or polymer melt 66 can comprise polymers that demonstrate the desired physical properties (e.g., mechanical or optical) and produce a desired embossed film product. For example, transparent polymers exhibiting a transmission (Tr) of greater than about 80%, or more specifically greater than about 90% (as measured by ASTM D1746-03), are desirable in optical film applications. One such polymer exhibiting these properties and has been successfully employed is polycarbonate (e.g., Lexan®, manufactured by General Electric Company, GE Polymers, Pittsfield, Mass.). The thickness of the substrate film 30 can comprise a thickness of about 2.0 mils (50.8 μm) to about 100.0 mils (2,540 μm). However, the embossing apparatus and methods discussed herein are equally applicable to partially transparent, translucent, or even opaque films/film materials.

The masking film 54 functions to protect the surface finish of the embossed film 32 during secondary manufacturing operations and/or handling. The masking film 54 process is optional, and is illustrated and discussed herein for completeness. Polymeric materials can be employed for the masking film 28. It is desirable that the masking film 54 comprises a polymer that can be easily removed from the embossed film 32 and is cost effective for the manufacturer. It is also desirable that the masking film 54 can be easily applied to the embossed film 32, typically pressure sensitive materials are suitable for this application. For example, one such polymer that has exhibited success is high-density polyethylene (e.g., Marlex®, manufactured by Chevron Phillips Chemical Company LLP, Woodlands, Tex.). The masking film 54 can comprise a 1 mil (25.4 μm) to about 20.0 mils (508 μm).

The width of the support film 28, substrate film 30, and masking film 54, can be any width compatible with the embossing apparatus in which they will be employed. Furthermore, the films are desirably similar in width to minimize edge scrap once cut to size. Yet, it is apparent that the specific size (e.g., thickness, width, etc.) employed for the masking film 54, support film 28, and substrate film 30, are each a function of the materials employed, the embossing process, end-users requirements and other variables, and therefore can be tailored based on the application.

The rolls (i.e., joining roll 36, heating roll 10, compression rolls 8, support rolls 14, take-up roll 38, idler roll 58, chill roll 12, embossing drum 68, and compression drum 70) are disposed in about axial alignment with one another to promote a uniform thickness and uniform residual stresses across the width of the embossed film 32. Furthermore, the rolls can be configured in any orientation and/or plurality that provide ample heating, cooling, compression, and support for the respective films. The rolls can be manufactured from metals (e.g., copper, aluminum, and iron), metal alloys (e.g., martensitic, ferritic, and austenitic stainless materials), polymers (e.g., ethylene propylene diene monomer based rubber (EPDM), and silicone), as well as configurations comprising at least one of the following. For example, in one embodiment, a roll can comprise 316 stainless steel having a chromed external surface.

The outer surface of the rolls generally comprises a smooth, polished finish if the roll is employed for routing any of the respective films (e.g., joining roll 36, heating roll 10, compression rolls 8, support rolls 14, take-up roll 38, idler roll 58, chill roll 12, and compression drum 70). However, if employed for forming surface features, such as embossing drum 68, the outer surface can comprise a texture, pattern, and the like. The rolls can also comprise heating elements, flow paths and/or conduits, and so forth, to enable control of the roll's temperature. For example, the heating roll 10 can be configured to comprise an internal geometry comprising a spiral flow path through which a heated media (e.g., oil, or water) can flow. The flow path can comprise an inlet disposed on one end of the roll's axel and an outlet disposed on the other end of the roll's axel. In another example, the heating roll 10 can comprise a spirally wrapped resistive heating element capable of connecting to an electrical source and heating the roll. Alternatively, chill roll 12 can comprise an internal flow path wherein a cooling media (e.g., water, or ethylene glycol) can flow therethrough to provide effective cooling of the chill roll 12.

During operation, the nip sections can exert a compressive force of about 10 pounds per square inch, lb/in² (0.703 kilograms per centimeters squared, kg/cm²) to about 100 lb/in² (7.03 kg/cm²) on the film, or more specifically about 25 lb/in² (1.757 kg/cm²) to about 90 lb/in² (6.328 kg/cm²), or even more specifically about 50 lb/in² (3.513 kg/cm²) to about 80 lb/in² (5.625 kg/cm²). The joining roll 36 can exert about 0.1 lb/in² (0.007 kg/cm²) to about 10 lb/in² (0.703 kg/cm²) on the film, or more specifically about 0.5 lb/in² (0.035 kg/cm²) to about 5 lb/in² (0.352 kg/cm²), or even more specifically about 1.0 lb/in² (0.070 kg/cm²) to about 2.5 lb/in² (0.176 kg/cm²).

The embossing belt 16 and/or embossing drum 68 (hereinafter referred to as embossing elements) can be formed from a metal (e.g., nickel), metal alloy (e.g., martensitic, ferritic, austenitic stainless materials, and nickel-titanium alloy), polymer (e.g., EPDM or silicone), as well as combinations comprising at least one of the foregoing. The embossing elements can be formed from methods such as etching, electrical discharge machining, stamping, milling, deposition processes (e.g., plasma discharge), and the like. For example, a nickel embossing belt 16 comprising a thickness of about 5 mils (127 μm) to about 30.0 mils (762 μm) can be formed from one of several processes such as plasma deposition or electroless deposition process. In another embodiment, the embossing drum 68 can comprise a center drum and an external embossing sleeve disposed thereon, wherein the embossing sleeve is formed from a nickel deposition process. In addition, the embossing elements can be configured to comprise any configuration of surface features that produce a desirable embossed film 32.

Belt heater 18 and the pre-embossing heater 26 (hereinafter referred to as “heaters”) can be disposed in any configuration (e.g., employ multiple heaters) and comprise any method of heating (e.g., irradiative, inductive, conductive, and/or convective methods) that is capable of heating at least one of the substrate film 30, support film 28, embossing belt 16, and supported film 34, as well as combinations comprising at least one of the foregoing. In one exemplary embodiment, the belt heater 18 is capable of heating the embossing belt 16 from about 100° F. (38° C.) up to about 450° F. (232° C.), and the pre-embossing heater 26 is capable of heating the supported film 34 from about 65° F. (18.3° C.) up to about 500° F. (260° C.), which is greater than the glass transition temperature of the polymer employed for the substrate film 30. More specifically, the film temperature achieved during the pre-heating section can be greater than or equal to the embossing temperature, yet lower that the Tg/Tm of the support film. In addition, although the heaters are shown disposed next to the bottom surface of the embossing belt 16, it is to be apparent that the heaters can be configured in any orientation about the embossing belt 16, for example, disposed near idler roll 58 and/or facing both surfaces of the embossing belt 16. For example, preheating can be at temperatures of about 65° F. (18° C.) to about 450° F. (232° C.), or, more specifically, about 100° F. (38° C.) to about 350° F. (177° C.), or, even more specifically, about 120° F. (49° C.) to about 250° F. (121° C.); while, the film embossing can be at temperatures of about 250° F. (121° C.) to about 600° F. (316° C.), or, more specifically, about 300° F. (149° C.) to about 500° F. (260° C.), or, even more specifically, about 375° F. (191° C.) to about 450° F. (323° C.).

Also, although not illustrated, process controllers, temperature controllers, and sensors (e.g., thermocouples, infrared temperature sensors) can be employed to control the output of the heaters. In one embodiment, the belt heater 18 can be controlled by a proportional-integral-derivative (PID) controller utilizing a closed-loop feedback method based on the temperature of the embossing belt 16, and the pre-embossing heater 26 can be controlled utilizing a PID controller configured in a closed-loop manner based on temperature feedback from the support film 28, wherein the controllers employ infrared temperature sensors.

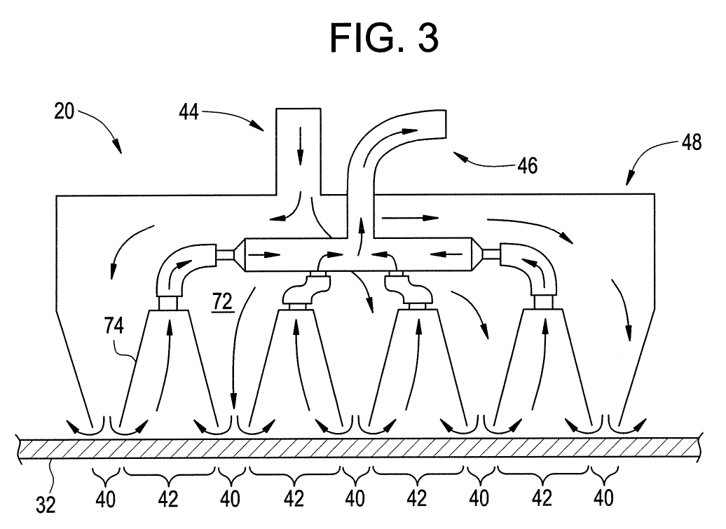

Referring now to FIG. 3, a cross-sectional front view of an exemplary cooling apparatus, generally designated 20, is illustrated. The cooling apparatus 20 comprises a shell 48 that defines a cooling jets 40 and vacuum conduits 42. The cooling jets 40 are capable of dissipating heat from the embossed film 32 by supplying a volume of cooling media 72 over the embossed film 32. As the cooling media 72 absorbs heat from the embossed film 32, a warmed media 74 is formed and removed via vacuum conduits 42. The cooling media 72 can be any media capable of cooling the embossed film 32, such as gases, liquids, and combinations comprising at least one of the foregoing. The cooling media 72 employed herein comprises cooled air. It is noted that the cooling media 72 is generally cleaned in pre-filtering step(s) to meet the clean room and quality specifications of the product.

The shell 48 comprises an air connector 44 that is connected in operable communication to an air source 22, which is connected to the cooling jets 40. A vacuum connector 46 extends through the shell 48 and is connected in operable communication to vacuum conduits 42. The vacuum connector 46 is connected in operable communication with a vacuum source 24. The cooling apparatus 20 can be configured with alternating cooling jets 40 and vacuum conduits 42, which can be configured in any configuration or orientation.

The air source 22 can comprise any apparatus capable of pressurizing and forming a cooling media 72, such as a rotary vane compressor configured with a heat exchanger. The cooling media 72 can comprise a temperature that is capable of reducing the temperature of the embossed film 32. For example, the cooling media 72 can comprise a temperature of about 40° F. (4° C.) to about 80° F. (27° C.), or more specifically about 40° F. (4° C.) to about 70° F. (21° C.), or even yet more specifically about 40° F. (4° C.) to about 50° F. (16° C.). The flow rate of the cooling media can be capable of reducing the temperature of the film. For example, a flow rate of about 100 cubic feet per minute, ft³/min (2.83 cubic meters per minute, M³/min) to about 2,000 ft³/min (56.6 M³/min), or more specifically at about 500 ft³/min (14.2 M³/min) to about 1,500 ft³/min (42.5 M³/min) can be employed. The vacuum source 24 can comprise any apparatus capable of producing a vacuum, such as a vacuum pump. The vacuum source 24 can operate at a flow rate of about 100 ft³/min (2.83 M³/min) to about 2,000 ft³/min (56.6 M³/min), or more specifically at about 500 ft³/min (14.2 M³/min) to about 1,500 ft³/min (42.5 M³/min). It is to be apparent that the temperature and flow rates employed are dependent on processing variables (e.g., film temperature or line speed) and can therefore be tailored for each application.

Although the cooling jets 40 are illustrated to provide a jet of cooling media 72 that is generally perpendicular to the embossed film 32, the cooling jets 40 can be angled to direct the jet of air in a desired direction (e.g., at an angle to the embossed film 32) to improve the airflow (e.g., improve airflow across the surface of the embossed film 32). The cooling jets 40 can also comprise nozzle(s) to improve the cooling efficiency. Furthermore, it is to be apparent that the cooling jets 40 and vacuum conduits 42 can comprise any configuration, orientation, and plurality that efficiently removes heat from the embossed film 32.

The cooling apparatus 20 can comprise any width that is capable of removing heat across the entire width of the embossed film 32. The length of the cooling apparatus can be configured to attain the desired amount of heat removal, which will be dependent on operating parameters such as: embossed film thickness 32, embossing belt 16 thickness, mask film thickness, heat transfer coefficients, air flow rate, and so forth, and can therefore be tailored for each application.

The shell 48 of the cooling apparatus 20 can be manufactured from metals (e.g., copper, aluminum, and iron), metal alloys (e.g., martensitic, ferritic, and austenitic stainless materials), polymeric materials (e.g., polysulfone and, acrylonitrile butadiene styrene), as well as combinations comprising at least one of the foregoing.

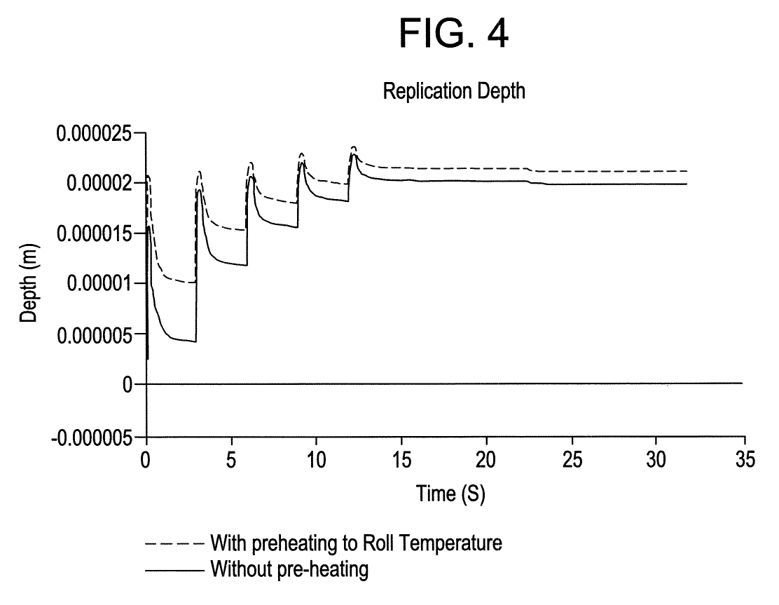

Referring now to FIG. 4, an exemplary graph illustrating embossing depth plotted with respect to time is illustrated. In the illustration, two runs are depicted, which were both conducted at a line speed of 5 feet per minute, ft/min (1.52 M/min). The graph's vertical axis represents depth in meters (m), and the horizontal axis represents time in seconds (s). The first set of data entitled “Without pre-heating” was conducted without employing a belt heater 18 or a pre-embossing heater 26. The second set of data entitled “With preheating to roll temperature” was conducted using a belt heater 18 and a pre-embossing heater 26, which preheated the substrate film 30 to the temperature of the heating roll 10. As can be seen in the graph, the embossing depth varies significantly as the embossing line is starting up, which comprises the period of time up to about 15 seconds. After about 15 seconds the embossing depth is generally stable for both runs. When the runs are compared, it can be seen that the process that employed belt heater 18 and pre-embossing heater 26 achieved greater embossing depth, hence greater replication fidelity.

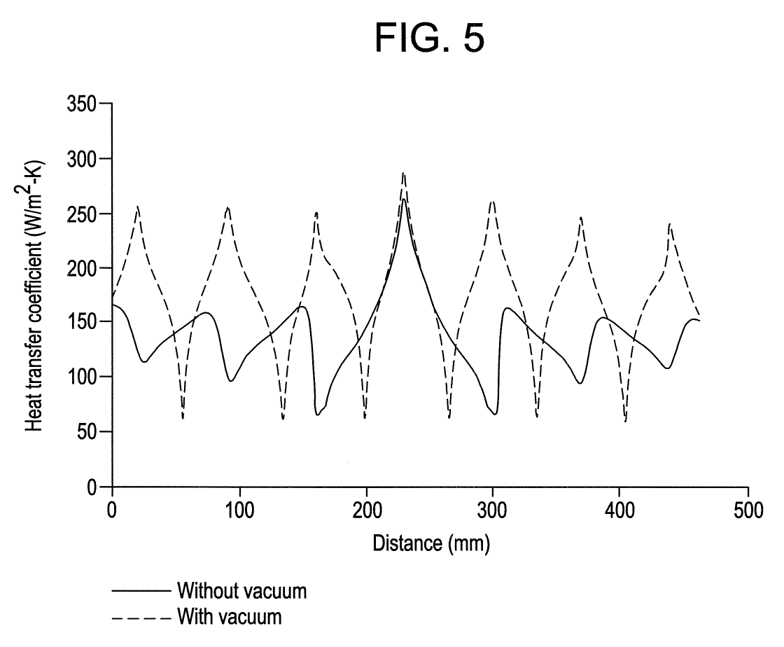

Referring now to FIG. 5, an exemplary graph illustrating the heat transfer effects of the redesigned cooling apparatus 20 is shown. In the illustration, the vertical axis represents the heat transfer coefficient in Watts per square meter Kelvin (W/(m²K)), and on the horizontal axis the length of an exemplary cooling apparatus 20 is graphed in millimeters (mm). The cooling apparatus 20 modeled comprised seven cooling jets 40 and six vacuum conduits 42. The first data set entitled “Without Vacuum” comprises a center peak exhibiting a heat transfer coefficient of about 260 W/(m²K), which is caused by the cooling jet 40 in the center of the cooling apparatus 20. On either side of the center peak, the additional cooling jets 40 attain heat transfer coefficients of about 160 W/(m²K). The second data set entitled “With Vacuum” comprises a center peak that exhibits a coefficient of about 280 W/(m²K). On either side of the center peak, the additional cooling jets 40 provide coefficients of about 250 W/(m²K). Comparing the data, it is established that the cooling apparatus 20 that incorporates a vacuum can achieve a higher heat transfer coefficient than a cooling apparatus 20 that does not employ vacuum.

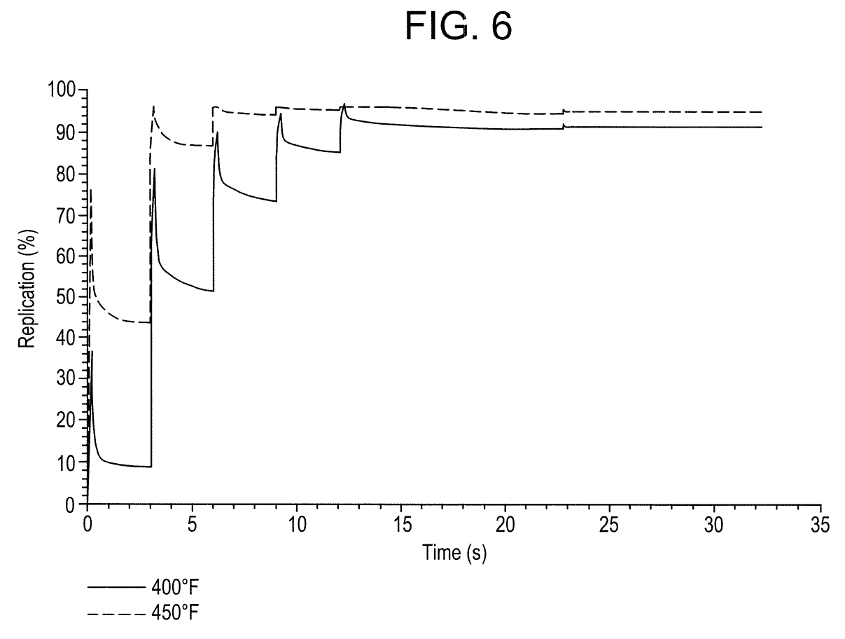

Referring now to FIG. 6, an exemplary graph illustrates embossing replication as a percentage from 0% to 100%. Replication percentage is calculated by comparing the height of the surface features formed on an embossed film 32 to the depth of the surface features disposed on the embossing apparatus (e.g., embossing belt 16 or embossing drum 68). For example, if an embossing belt comprising surface features having a depth of 1.0 mm (39.4 mil) is employed to manufacture an embossed film 32, and the embossed film 32 exhibits surface features that are 0.95 mm (37.4 mil) in height, the embossed film exhibits 95% replication.

In the graph, the replication percentage is plotted with respect to time for an embossing line 2 that was run at a production rate of 15 feet per minute. In the graph, two data sets are presented; the first data set entitled “400° F.”, which represents a run conducted with the belt heater 18 and the pre-embossing heater 26 producing a substrate film 30 temperature of 400° F. (204° C.) before the film entered the first nip section. A second data set presented, entitled “450° F.”, represents a run conducted with the belt heater 18 and pre-embossing heater 26 produced a substrate film 30 temperature of 450° F. (232° C.) before the film entered the first nip section. As can be seen, both runs produced over 90% replication once they stabilized after about 25 seconds. This is of interest as a replication percentage of over 90% was previously unobtainable at such line speeds.

In addition, it can also be seen that the ability to preheat the substrate film 30 prior to embossing reduces the amount of time to produce films with a replication percentage over 90% (about 6 seconds for the 450° F. run and about 12 seconds for the 400° F. run), as well potentially reduces the duration of time for the process to stabilize (about 12 seconds for the 450° F. run and about 23 seconds for the 400° F. run). For example, for a line without the preheater(s), the replication fidelity would be about 40% to 70% at the above hot roll temperatures and at 15 feet per minute (FPM).

In conclusion, the embossing line 2 disclosed herein incorporates several modifications, which have enabled the production of high quality embossed films. To be more specific, it has been shown herein that preheating the substrate film 30 prior to embossing improves replication depth (FIG. 4), can produce a replication fidelity percentage of over about 90% at line speeds of 15 FPM (FIG. 6), and can reduce the start-up time of the embossing line 2 (FIG. 6). In addition, it has also been shown that the cooling apparatus 20 can more efficiently remove heat from a substrate film 30 (FIG. 5). Through these modifications, manufactures can now increase product throughput and realize the efficiencies and benefits associated therewith.

Unless defined otherwise, technical and scientific terms used herein have the same meaning as is commonly understood by one of skill in the art to which this invention belongs. The terms “first,” “second,” and the like, as used herein do not denote any order, quantity, or importance, but rather are used to distinguish one element from another. Also, the terms “a” and “an” do not denote a limitation of quantity, but rather denote the presence of at least one of the referenced item, and the terms “front”, “back”, “bottom”, and/or “top”, unless otherwise noted, are merely used for convenience of description, and are not limited to any one position or spatial orientation. If ranges are disclosed, the endpoints of all ranges directed to the same component or property are inclusive and independently combinable (e.g., ranges of “up to about 25 wt. %, or, more specifically, about 5 wt. % to about 20 wt. %,” is inclusive of the endpoints and all intermediate values of the ranges of “about 5 wt. % to about 25 wt. %,” etc.). The modifier “about” used in connection with a quantity is inclusive of the stated value and has the meaning dictated by the context (e.g., includes the degree of error associated with measurement of the particular quantity). The suffix “(s)” as used herein is intended to include both the singular and the plural of the term that it modifies, thereby including one or more of that term (e.g., the colorant(s) includes one or more colorants). Furthermore, as used herein, “combination” is inclusive of blends, mixtures, alloys, reaction products, and the like.

While the invention has been described with reference to a preferred embodiment, it will be understood by those skilled in the art that various changes may be made and equivalents may be substituted for elements thereof without departing from the scope of the invention. In addition, many modifications may be made to adapt a particular situation or material to the teachings of the invention without departing from essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. An embossing line, comprising:
an embossing belt disposed about a heating roll and a chill roll;
a joining roll disposed between the heating roll and the chill roll such that the joining roll can dispose a substrate film on the embossing belt prior to the embossing belt contacting the heating roll; and,
a pre-embossing heater disposed between the joining roll and the heating roll such that the substrate film can be heated by the pre-embossing heater prior to the embossing belt contacting the heating roll.

2. The embossing line of claim 1, further comprising a cooling apparatus comprising a cooling jet and a vacuum conduit, wherein the cooling apparatus is disposed such that an embossed film can be cooled.

3. The embossing line of claim 1, further comprising a belt heater disposed between the chill roll and the joining roll such that the embossing belt can be heated prior to the joining roll.

4. The embossing line of claim 1, further comprising an idler roll positioned such that the substrate film can be supplied to the joining roll at an acute angle.

5. The embossing line of claim 4, wherein the acute angle is greater than or equal to about 15°.

6. The embossing line of claim 5, wherein the acute angle is greater than or equal to about 30°.

7. The embossing line of claim 6, wherein the acute angle is greater than or equal to about 45°.

8. An embossing line, comprising:
an extruder capable of extruding a polymer melt onto a nip section between an embossing drum and a compression drum to form an embossed film; and,
a cooling apparatus capable of cooling the embossed film, wherein the cooling apparatus comprises a cooling jet and a vacuum conduit.

9. A film making process, comprising:
disposing a substrate film and a support film on an embossing belt to form a supported film;
heating the supported film to form a heated supported film;
introducing the heated supported film into a first nip section; and,
forming an embossed film, wherein the embossed film comprises surface features.

10. The process of claim 9, further comprising heating the embossing belt prior to disposing the substrate film and support film on the embossing belt.

11. The process of claim 9, wherein the substrate film is heated above its glass transition temperature.

12. The process of claim 9, further comprising:
blowing a cooling media at a surface of the embossed film;
removing heat energy from the embossed film with the cooling media to form a warmed media; and,
applying a vacuum to at least a portion of the warmed media.

13. The process of claim 9, wherein the substrate film comprises a polycarbonate.

14. The process of claim 9, wherein the support film comprises a polyethylene terephthalate

15. The process of claim 9, further comprising producing the embossed film at a rate of greater than or equal to about 10 feet per minute, wherein the surface features comprise a replication percentage of greater than or equal to about 90%.

16. The process of claim 15, wherein the rate is greater than or equal to about 20 feet per minute.

17. The process of claim 16, wherein the rate is greater than or equal to about 30 feet per minute.

18. An film making process, comprising:
extruding a polymer melt onto a nip section formed by an embossing drum and a compression drum;
forming an embossed film, wherein the embossed film comprises surface features;
blowing a cooling media at a surface of the embossed film;
removing heat energy from the embossed film with the cooling media to form a warmed media; and,
applying a vacuum to at least a portion of the warmed media.

19. The process of claim 18, further comprising producing the embossed film at a rate of greater than or equal to about 10 feet per minute, wherein the surface features comprise a replication percentage of greater than or equal to about 90%.

20. The process of claim 19, wherein the rate is greater than or equal to about 20 feet per minute.
